(19) United States
(12) Patent Application Publication
(10) Pub. No.: US 2018/0046940 A1
(43) Pub. Date: Feb. 15, 2018

(54) OPTIMIZED MACHINE LEARNING SYSTEM

(71) Applicant: Google Inc., Mountain View, CA (US)

(72) Inventors: Patrick Hummel, Cupertino, CA (US); Uri Nadav, Menlo Park, CA (US)

(21) Appl. No.: 15/352,318

(22) Filed: Nov. 15, 2016

Related U.S. Application Data
(60) Provisional application No. 62/375,091, filed on Aug. 15, 2016.

(51) Int. Cl. G06N 99/00

(52) U.S. Cl. CPC G06N 99/005

(57) ABSTRACT

Methods, systems, and apparatus, including computer programs encoded on a computer storage medium, for optimizing machine learning systems. In one aspect a method includes determining an average error of a machine learning system (“MLS”). An evaluation function that provides a result that would have been achieved using a specified value of a given parameter is defined. An expected outcome function that provides expected results for prior events based on the error of the MLS is defined. For each of multiple prior events, a target value of the given parameter is determined, e.g., using the expected outcome function. A model is generated using the MLS based on features of the prior events and the determined target values of the given parameter for the prior events. A value is assigned to the given parameter for a new event based on application of the model to features of the new event.

### CROSS-REFERENCE TO RELATED APPLICATIONS

This application claims the benefit under 35 U.S.C. §119(e) of U.S. Patent Application No. 62/375,091, entitled “OPTIMIZED MACHINE LEARNING SYSTEM,” filed Aug. 15, 2016. The disclosure of the foregoing application is incorporated herein by reference in its entirety for all purposes.

### BACKGROUND

This specification relates to data processing and optimization of machine learning systems.

The Internet facilitates the exchange of information and transactions between users across the globe. This exchange of information enables distribution of content to a variety of users. In some situations, content from multiple different providers can be integrated into a single electronic document to create a composite document. For example, a portion of the content included in the electronic document may be selected (or specified) by a publisher of the electronic document. A different portion of content (e.g., digital third-party content) can be provided by a third-party (e.g., an entity that is not a publisher of the electronic document). In some situations, the third-party content is selected for integration with the electronic document after a user has already requested presentation of the electronic document. For example, machine executable instructions included in the electronic document can be executed by a user device when the electronic document is presented at the user device, and the instructions can enable the user device to contact one or more remote servers to obtain third-party content that will be integrated into the electronic document.

### SUMMARY

In general, one innovative aspect of the subject matter described in this specification can be embodied in methods that include determining an average error of a machine learning system; defining an evaluation function that provides a result that would have been achieved using a specified value of a given parameter in prior events; defining an expected outcome function that provides expected results for prior events based on the error of the machine learning system; determining, for each of multiple prior events, a target value of the given parameter that causes the expected outcome function to provide a specified output for the prior event; generating a model using the machine learning system based on features of the prior events and the determined target values of the given parameter for the prior events; assigning a value to the given parameter for a new event based on application of the model to features of the new event; selecting third-party content for distribution to a client device based on the assigned value of the given parameter and selection values submitted by third-party content providers; and distributing, over a network, the selected third-party content to the client device. Other aspects include corresponding systems, devices, and computer readable medium.

These and other embodiments can each optionally include one or more of the following features. Defining the evaluation function can include defining the evaluation function to provide an output that specifies an amount of gain that would have been realized if a specified threshold eligibility value had been used to select third-party content.

Methods can include evaluating selection values submitted by third-parties for each of one or more prior requests, wherein, for each request, the evaluation function provides an output of zero when no third-party has submitted a selection value that meets the threshold eligibility value, provides an output of the threshold eligibility value when a single third-party submitted a submission value meeting the threshold eligibility value, and provides an output that is greater than the threshold eligibility value when multiple third-parties submitted a submission value meeting the threshold eligibility value.

Defining the expected outcome function can include defining the expected outcome function that outputs an amount of gain that would have been realized for a given request when the error of the machine learning system causes the actual threshold eligibility value to be higher or lower than a given threshold eligibility value for that given request, but the error does not prevent distribution of third-party content in response to the given request.

Determining the target value of the given parameter can include determining a threshold eligibility value that maximizes the gain output by the expected outcome function. Assigning the value to the given parameter can include outputting, from the model, the threshold eligibility value that will be used for selection of third-party content that is provided in response to the request. Selecting third-party content for distribution can include selecting content having a selection value that equals or exceeds the threshold eligibility value output by the model.

Particular embodiments of the subject matter described in this specification can be implemented so as to realize one or more of the following advantages. The subject matter described in this document improves the accuracy with which one or more servers (or other computing devices) are able to predict a value of a particular parameter by accounting for errors that are inherent in machine learning systems. The disclosed subject matter takes into account differences in the magnitude of adverse effects that result from different types of prediction errors (e.g., overestimates or underestimates) when training a predictive model so that the likelihood of more severe adverse effects are reduced. For example, in some situations, an overestimate by a predictive model can result in failure to distribute content in response to a request for content that is received from a user device, whereas an underestimate will still result in content being distributed. In such a situation, an overestimate has a higher magnitude adverse effect than the underestimate. The description that follows describes techniques for accounting for those differences when training a predictive model so that the magnitude of the errors by one or more servers (or other computing devices) will be reduced. As such, the functioning of the one or more servers (or other computing devices) is improved by mitigating the effect of the errors that are inherent in predictive technologies.

The subject matter discussed in this application enables third-party digital content (“third-party content”) to be distributed over the Internet within a specified amount of time (e.g., within a time constraint) following a request for the content. For example, the subject matter of this application enables a portion of third-party content to be distributed for inclusion in a web page (or native application) after the web page (or a given portion of the native application) has been requested, rendered and/or presented by a user device. The third-party content can be distributed and/or presented without delaying presentation of the web page (or given portion of the native application) and within a specified amount of time following the user's request for a web page (or given portion of the native application). Providing the third-party content for presentation within the specified amount of time prevents page loading errors (or other errors) that may occur if the third-party content is provided after the specified amount of time, and reduces the likelihood that the third-party content fails to be presented (e.g., due to timeout conditions or the user navigating away from the web page). In some implementations, the third-party content is selected within one second of the request.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example environment in which content is distributed.

FIG. 2 is a flow chart of an example process for optimizing a machine learning system.

FIG. 3 is a block diagram of an example computing device.

Like reference numbers and designations in the various drawings indicate like elements.

### DETAILED DESCRIPTION

This document discloses methods, systems, apparatus, and computer readable media that facilitate optimization of machine learning systems that are used to generate predictive models. As discussed in more detail below, the machine learning systems are optimized by taking into account the error of the machine learning system to generate a model that mitigates the potential negative impact of erroneous predictions. For example, in some situations, an error in one direction (e.g., an overestimate) may result in a more detrimental outcome than an error in the opposite direction (e.g., an underestimate). Standard machine learning techniques do not take this type of directional error into account when training models. As described below, the error of the machine learning system can be taken into account to lower the likelihood that the error corresponding to the higher detrimental effect is output by a model generated using the machine learning system, thereby optimizing the machine learning system and the results achieved using the model generated using the machine learning system. As used throughout this document, the term optimized (or optimal) does not necessarily refer to a most optimal outcome, but rather is used to refer to an improvement provided by implementing the techniques discussed below.

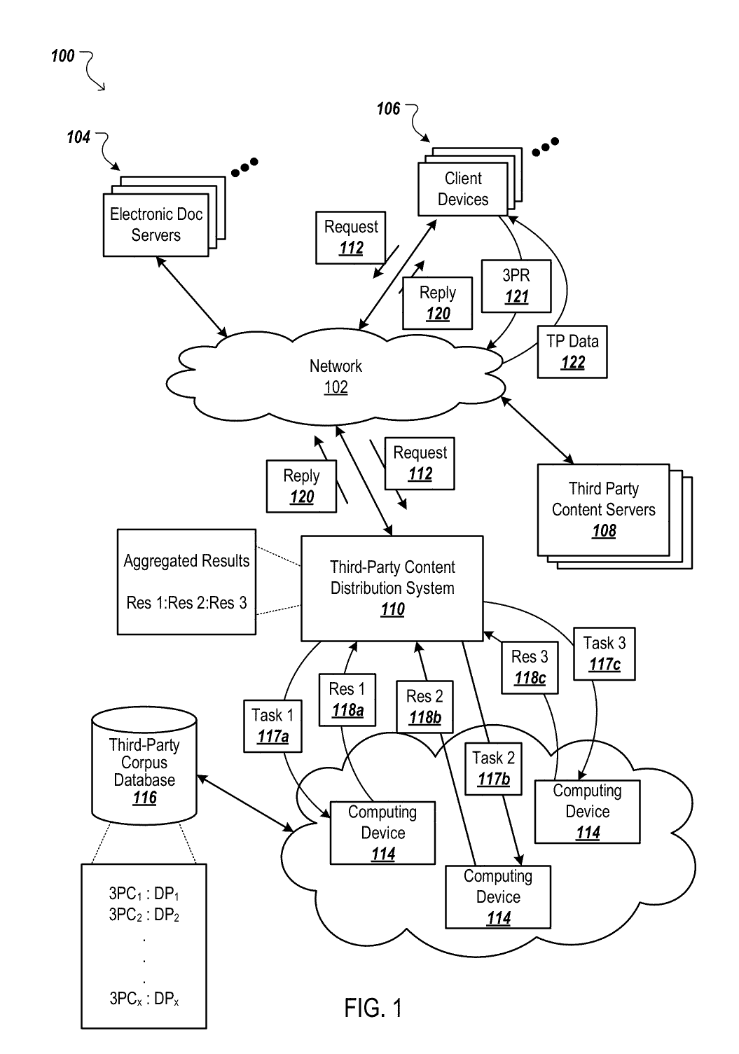

FIG. 1 is a block diagram of an example environment 100 in which third-party content is distributed for presentation with electronic documents. The example environment 100 includes a network 102, such as a local area network (LAN), a wide area network (WAN), the Internet, or a combination thereof. The network 102 connects electronic document servers 104, user devices 106, third-party content servers 108, and a third-party content distribution system 110 (also referred to as a content distribution system). The example environment 100 may include many different electronic document servers 104, user devices 106, and third-party content servers 108.

A client device 106 is an electronic device that is capable of requesting and receiving resources over the network 102. Example client devices 106 include personal computers, mobile communication devices, and other devices that can send and receive data over the network 102. A client device 106 typically includes a user application, such as a web browser, to facilitate the sending and receiving of data over the network 102, but native applications executed by the client device 106 can also facilitate the sending and receiving of data over the network 102.

An electronic document is data that presents a set of content at a client device 106. Examples of electronic documents include webpages, word processing documents, portable document format (PDF) documents, images, videos, search results pages, and feed sources. Native applications (e.g., “apps”), such as applications installed on mobile, tablet, or desktop computing devices are also examples of electronic documents. Electronic documents can be provided to client devices 106 by electronic document servers 104 (“Electronic Doc Servers”). For example, the electronic document servers 104 can include servers that host publisher websites. In this example, the client device 106 can initiate a request for a given publisher webpage, and the electronic server 104 that hosts the given publisher webpage can respond to the request by sending machine executable instructions that initiate presentation of the given webpage at the client device 106.

In another example, the electronic document servers 104 can include app servers from which client devices 106 can download apps. In this example, the client device 106 can download files required to install an app at the client device 106, and then execute the downloaded app locally.

Electronic documents can include a variety of content. For example, an electronic document can include static content (e.g., text or other specified content) that is within the electronic document itself and/or does not change over time. Electronic documents can also include dynamic content that may change over time or on a per-request basis. For example, a publisher of a given electronic document can maintain a data source that is used to populate portions of the electronic document. In this example, the given electronic document can include a tag or script that causes the client device 106 to request content from the data source when the given electronic document is processed (e.g., rendered or executed) by a client device 106. The client device 106 integrates the content obtained from the data source into the given electronic document to create a composite electronic document including the content obtained from the data source.

In some situations, a given electronic document can include a third-party tag or third-party script that references the third-party content distribution system 110. In these situations, the third-party tag or third-party script is executed by the client device 106 when the given electronic document is processed by the client device 106. Execution of the third-party tag or third-party script configures the client device 106 to generate a request for third-party content 112, which is transmitted over the network 102 to the third-party content distribution system 110. For example, the third-party tag or third-party script can enable the client device 106 to generate a packetized data request including a header and payload data. The request 112 can include event data specifying features such as a name (or network location) of a server from which the third-party content is being requested, a name (or network location) of the requesting device (e.g., the client device 106), and/or information that the third-party content distribution system 110 can use to select third-party content provided in response to the request. The request 112 is transmitted, by the client device 106, over the network 102 (e.g., a telecommunications network) to a server of the third-party content distribution system 110.

The request 112 can include event data specifying other event features, such as the electronic document being requested and characteristics of locations of the electronic document at which third-party content can be presented. For example, event data specifying a reference (e.g., URL) to an electronic document (e.g., webpage) in which the third-party content will be presented, available locations of the electronic documents that are available to present third-party content, sizes of the available locations, and/or media types that are eligible for presentation in the locations can be provided to the content distribution system 110. Similarly, event data specifying keywords associated with the electronic document (“document keywords”) or entities (e.g., people, places, or things) that are referenced by the electronic document can also be included in the request 112 (e.g., as payload data) and provided to the content distribution system 110 to facilitate identification of content items that are eligible for presentation with the electronic document. The event data can also include a search query that was submitted from the client device 106 to obtain a search results page.

Requests 112 can also include event data related to other information, such as information that the user has provided, geographic information indicating a state or region from which the request was submitted, or other information that provides context for the environment in which the third-party content will be displayed (e.g., a time of day of the request, a day of the week of the request, a type of device at which the third-party content will be displayed, such as a mobile device or tablet device). Requests 112 can be transmitted, for example, over a packetized network, and the requests 112 themselves can be formatted as packetized data having a header and payload data. The header can specify a destination of the packet and the payload data can include any of the information discussed above.

The third-party content distribution system 110 chooses third-party content that will be presented with the given electronic document in response to receiving the request 112 and/or using information included in the request 112. In some implementations, the third-party content is selected in less than a second to avoid errors that could be caused by delayed selection of the third-party content. For example, delays in providing third-party content in response to a request 112 can result in page load errors at the client device 106 or cause portions of the electronic document to remain unpopulated even after other portions of the electronic document are presented at the client device 106. Also, as the delay in providing third-party content to the client device 106 increases, it is more likely that the electronic document will no longer be presented at the client device 106 with the third-party content, thereby negatively impacting a user's experience with the electronic document. Further, delays in providing the third-party content can result in a failed delivery of the third-party content, for example, if the electronic document is no longer presented at the client device 106 when the third-party content is provided.

In some implementations, the third-party content distribution system 110 is implemented in a distributed computing system that includes, for example, a server and a set of multiple computing devices 114 that are interconnected and identify and distribute third-party content in response to requests 112. The set of multiple computing devices 114 operate together to identify a set of third-party content that are eligible to be presented in the electronic document from among a corpus of millions of available third-party content (3PC₁₋ₓ). The millions of available third-party content can be indexed, for example, in a third-party corpus database 116. Each third-party content index entry can reference the corresponding third-party content and/or include distribution parameters (DP₁-DPₓ) that condition the distribution of the corresponding third-party content.

In some implementations, the distribution parameters for a particular third-party content can include distribution keywords that must be matched (e.g., by electronic documents or terms specified in the request 112) in order for the third-party content to be eligible for presentation. The distribution parameters can also require that the request 112 include information specifying a particular geographic region (e.g., country or state) and/or information specifying that the request 112 originated at a particular type of client device (e.g., mobile device or tablet device) in order for the third-party content to be eligible for presentation. The distribution parameters can also specify a selection value (e.g., bid) for distributing the particular third-party content.

The identification of the eligible third-party content can be segmented into multiple tasks 117a-117c that are then assigned among computing devices within the set of multiple computing devices 114. For example, different computing devices in the set 114 can each analyze a different portion of the third-party corpus database 116 to identify various third-party content having distribution parameters that match information included in the request 112. In some implementations, each given computing device in the set 114 can analyze a different data dimension (or set of dimensions) and pass results (Res 1-Res 3) 118a-118c of the analysis back to the third-party content distribution system 110. For example, the results 118a-118c provided by each of the computing devices in the set may identify a subset of third-party content that are eligible for distribution in response to the request and/or a subset of the third-party content that have certain distribution parameters.

The third-party content distribution system 110 aggregates the results 118a-118c received from the set of multiple computing devices 114 and uses information associated with the aggregated results to select one or more third-party contents that will be provided in response to the request 112. For example, the third-party content distribution system 110 can select a set of winning third-party content based on the outcome of one or more content evaluation processes. In turn, the third-party content distribution system 110 can generate and transmit, over the network 102, reply data 120 (e.g., digital data representing a reply) that enable the client device 106 to integrate the set of winning third-party content into the given electronic document, such that the set of winning third-party content and the content of the electronic document are presented together at a display of the client device 106.

In some implementations, the client device 106 executes instructions included in the reply data 120, which configures and enables the client device 106 to obtain the set of winning third-party content from one or more third-party content servers. For example, the instructions in the reply data 120 can include a network location (e.g., a Uniform Resource Locator (URL)) and a script that causes the client device 106 to transmit a third-party request (3PR) 121 to the third-party content server 108 to obtain a given winning third-party content from the third-party content server 108. In response to the request, the third-party content server 108 will transmit, to the client device 106, third-party data (TP Data) 122 that causes the given winning third-party content to be incorporated to the electronic document and presented at the client device 106.

The content distribution system 110 can specify conditions for selecting the set of winning third-party content for each given request (e.g., based on event data corresponding to the request). In some implementations, the evaluation process is not only required to determine which third-party content to select for presentation with the electronic document, but also the price that will be paid for presentation of the selected third-party content. In some situations, the content distribution system 110 will set a threshold eligibility value (e.g., reserve price) for a given request, which specifies the minimum amount that must be paid (e.g., a minimum bid) for a third-party content to be provided in response to a request. As discussed in more detail below, the threshold eligibility value can be specified on a per event basis (e.g., for each different request) based on event data corresponding to the event.

The threshold eligibility value for an event (e.g., content distribution request) can be set using a predictive model that is generated by a machine learning system. For example, using a predictive model that outputs a threshold eligibility value based on request data corresponding to a content distribution request (e.g., a multi-dimensional vector of data that contains attributes of the content distribution request), a threshold eligibility value can be set for that content distribution request (“request”). However, models generated by machine learning systems generally have some level of prediction error, which can adversely affect the distribution of third-party content. For example, if the threshold eligibility value is set too high (e.g., higher than any amount that third-party content providers are willing to pay given the attributes of the request), then no third-party content will be selected to be provided in response to the request, such that the electronic document that is presented at the client device 106 will be missing content. In contrast, third-party content will still be provided in response to a request if the threshold eligibility value is set at an amount that is lower than the amount that at least one of the third-party content providers is willing to pay. As such, the adverse effect of overestimating the threshold eligibility value for a given request is generally worse than underestimating the threshold eligibility value.

Existing machine learning systems do not differentiate between overestimates and underestimates, because the machine learning treats the effect of a given magnitude of prediction error to be substantially the same irrespective of the direction (e.g., overestimate or underestimate) of the prediction error. This similar treatment of overestimates and underestimates by the machine learning system increases the likelihood that the threshold eligibility values generated using machine learning systems may lead to a failed third-party content delivery (e.g., by overestimating the threshold eligibility value). Techniques similar to those described below can be used to reduce the likelihood that machine learning generated threshold eligibility values will lead to a failed third-party content delivery, while also improving the accuracy of the threshold eligibility values that are output, which improves the functioning of one or more computers that are used to implement the machine learning system by improving the accuracy of the results provided by those one or more computers. For example, the techniques described below consider the effect of directional error (e.g., overestimate or underestimate) for purposes of generating a model that predicts threshold eligibility values for specific requests.

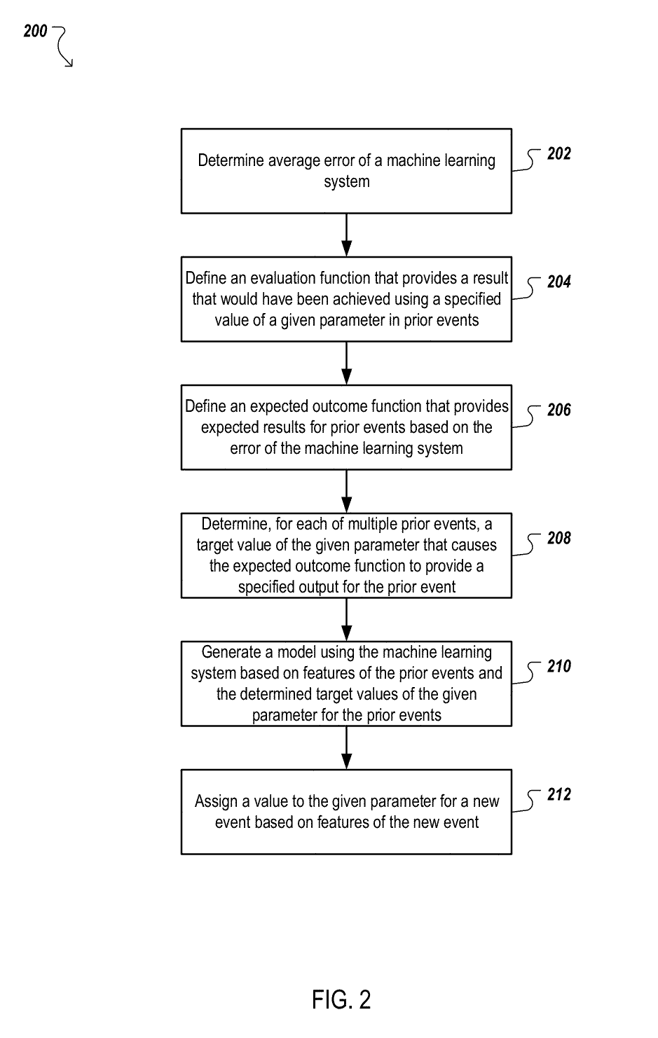

FIG. 2 is a flow chart of an example process 200 for optimizing prediction accuracy of a prediction model implemented in a machine learning system. As discussed in more detail below, the prediction optimization adjusts the prediction model in a way that reduces the likelihood that a small prediction error in one direction (e.g., an overestimate) will lead to a large system-level error. The process 200 can be used in various situations in which one type of error (e.g., an overestimate or an underestimate) has a more detrimental effect on operation of a system than the other type of error (e.g., an underestimate or an overestimate).

Operations of the process 200 can be implemented by one or more servers (or other computing devices), such as the third-party content distribution system 110 of FIG. 1. Operations of the process 200 can also be implemented as instructions stored on a non-transitory computer readable medium, where execution of the instructions by one or more servers (or other computing devices) cause the one or more servers to perform operations of the process 200.

An average error of a machine learning system is determined (202). In some implementations, the average error can be determined in log space, and the determination can be based on historical predictions made by the machine learning system. For example, assume that the machine learning system has been used to train a model that predicts average selection values (e.g., average bids) that will be submitted by third-party content providers for upcoming requests. In this example, the average error of the machine learning system may be the average difference between the predicted average selection values and the actual average selection values of the submitted selection values. The average difference can be determined, for example, by obtaining the difference (e.g., mathematical difference) between the predicted selection value for each request and the actual selection for each request, and then taking an average (or other measure of central tendency) of the differences. Other measures of error can also be used.

An evaluation function (“Rᵢ(r)”) is defined (204). The evaluation function is a function that provides a result (e.g., an amount of gain) that would have been achieved using a specified given parameter in prior events, thereby enabling evaluation of the results that would have been achieved had the specified given parameter been previously used. In some implementations, the resulting output of the evaluation function is an amount of gain (e.g., revenue) that would have been realized if a specified threshold eligibility value of r had been used to select third-party content in response to a prior request. For example, for each of multiple different threshold eligibility values (e.g., 0.01-1.00), the evaluation function can use the threshold eligibility value r as the minimum selection value (e.g., bid) that must be submitted by a third-party content provider in order for third-party content from that provider to be distributed. For each of one or more prior requests, the evaluation function evaluates the selection value submitted by third-party content providers for that request, and identifies the resulting gain. For example, if no third-party content providers submitted a selection value that meets (e.g., equals or exceeds) the threshold eligibility value r, the gain is zero. If a single third-party content provider submitted a selection value that meets or exceeds the threshold eligibility value r, the gain equals the threshold eligibility value r, and if multiple third-party content providers submitted selection values that meet or exceed the threshold eligibility value r, the gain can be determined, for example, based on (e.g., set equal to or an incremental amount higher than) a second highest submitted selection value, according to a second-price mechanism (e.g., auction).

For purposes of illustration, assume that for a given prior request, there are s presentation slots available for presentation of third-party content, and the position normalizers (e.g., adjustment factors that normalize relative performance of the various presentation slots, and are generally in the range of [0,1]) for these presentation slots are c₁, . . . , cₛ, where c₁>c₂> . . . >cₛ>0. Also assume that the s+1 highest selection values submitted by third-party content providers are b₁, . . . bₛ₊1, where b₁≧ . . . ≧bₛ₊₁>0, where bₖ=0 if fewer than k selection values were submitted. Further assume that the threshold eligibility value is set to r. In this example, if r<bₛ₊₁, then the resulting gain will be Σⱼ₌₁^{s}Cⱼbⱼ₊₁. If bₛ₊₁<r<b₁ and k denotes the largest integer for which r≦bₖ, then the resulting gain will be cₖr+Σⱼ₌₁^{k=1}cⱼbⱼ₊₁. If r>b₁, then the resulting gain is 0.

Assuming that Rᵢ(r) denotes the amount of gain realized when the gain is determined using a generalized second-price mechanism i with a threshold eligibility value of r, position normalizers c₁, . . . , cₛ, and selection values b₁, . . . bₛ₊₁, then the evaluation function can be defined as Rᵢ(r)=Σⱼ₌₁^{S}c_{i,j}b_{i,j+1} when r≦b_{i,s+1}, Rᵢ(r)=c_{i,k}r+Σⱼ₌₁^{k-1}c_{i,j}b_{i,j+1} when b_{i,s+1}<r<b_{i,1} and k denotes the largest integer for which r<b_{i,k}, and Rᵢ(r)=0 when r>b_{i,1}. Other gain functions can be defined and/or used; this gain function is simply provided for purposes of example, and to demonstrate an example gain function that can be used when a generalized second-price mechanism is used.

An expected outcome function is defined (206). The expected outcome function provides expected results for prior events based on the error of the machine learning system. In some implementations, the output of the expected outcome function is an amount of gain that would have been realized for a given request when the error of the machine learning system causes the actual threshold eligibility value to be higher or lower than a given (e.g., maximum possible) threshold eligibility value for that given request that still results in distribution of third-party content (e.g., does not exceed a highest submitted selection value for that request, and does not prevent distribution of third-party content in response to that request). For example, assuming that a particular threshold eligibility value would provide a highest amount of gain, the expected outcome function provides a result that represents the outcome when errors in the machine learning system cause the actual threshold eligibility value to differ from the particular threshold eligibility value. In some implementations, the expected outcome function can provide the gain that would be realized when the predicted threshold eligibility value differs from the target threshold eligibility value by some multiple of a log-normally distributed error term, where the log of the error term has a variance of σ² and a mean of −σ²/2, such that the error term has a mean of zero. In some implementations, the error injected threshold eligibility value (e.g., the threshold eligibility value used in the expected outcome function) is set to the target threshold eligibility value r times a randomly selected error term x selected from a log-normal distribution of error terms.

An example expected outcome function is provided below in relationship (1):

E[Rᵢ(r)]=∫₀^{∞}Rᵢ(xr)ƒ(x)dx (1)

where ƒ(x) is a function that equals the density corresponding to a lognormal distribution with parameters μ=−σ²/2 and σ². More specifically, an example function ƒ(x) is provided below in relationship (2):

$$f ( x ) = \frac{1}{x σ \sqrt{2 π}} {e}^{- {ln ( x - \frac{{σ}^{2}}{2} )}^{2} / 2 {σ}^{2}} \qquad ( 2 )$$

where x is the error term.

For each of multiple prior events, a target value of the given parameter is determined (208). The target value of the given parameter is a value that causes the expected outcome function to provide a specified output for the prior event. In some implementations, the target value of the given parameter is the optimal threshold eligibility value (e.g., the threshold eligibility value that maximizes the gain output by the expected outcome function). The target threshold eligibility value can be determined, for example, using relationship (3), which is derived from the expected outcome function of relationship (1):

$$\frac{d}{dr} E [ {R}_{i} ( r ) ] = - \frac{{c}_{i , s} {b}_{i , 2}^{2}}{{r}^{2}} f ( \frac{{b}_{i , s}}{r} ) - … - \frac{{c}_{i , 1} {b}_{i , 1}^{2}}{{r}^{2}} f ( \frac{{b}_{i , 1}}{r} ) + {\int }_{\frac{{b}_{i , s + 1}}{r}}^{\frac{{b}_{i , s}}{r}} {c}_{i , s} xf ( x ) dx + … + {\int }_{\frac{{b}_{i , 2}}{r}}^{\frac{{b}_{i , 1}}{r}} {c}_{i , 1} xf ( x ) dx \qquad ( 3 )$$

The optimal target threshold eligibility value can be found by identifying those values of r that cause relationship (3) to equal zero. Those identified values of r can then be evaluated using the expected outcome function in relationship (1) to identify the value of r that provides the highest gain.

As noted above, the operations described with reference to (208) can be performed for each of multiple different prior events. For example, the target value of r can be determined for each prior request for third-party content.

A model is generated based on features of the prior events and the determined target values of the given parameter for the prior events (210). The model is generated, for example, by the machine learning system, which can output a model that predicts a threshold eligibility value for requests based on the features of the request. The features of the request can take the form of a multi-dimensional feature vector V, in which the value of each dimension represents an attribute of the request. For example, one dimension of the feature vector V can represent a keyword that is specified in the request, while other dimensions of the vector V can represent attributes such as a time of day when the request was submitted, a day of the week when the request was submitted, a geographic region from which the request was submitted, a category of content specified in the request, information about a user that will be presented with third-party content provided in response to the request, as well as various other attributes. The model can be trained, for example, to fit log(rᵢ) as a linear function of the various features using machine learning techniques, such as linear regression.

As discussed above, the fact that there will be errors in predictions (e.g., predicted optimal threshold eligibility values) output by the model should be considered when training the model to reduce the likelihood that the predicted optimal threshold eligibility values output by the model will exceed all selection values that are ultimately submitted for the request. The error is taken into account, for example, by using the target values determined above when generating the model because the target values were determined using relationships that accounted for the error (e.g., term x).

For purposes of example, assume that there are Y features in the model. Also assume that for a given third-party content selection z,y_{z} denotes the values assumed by the various features for that third-party content selection. In this example, y_{z} denotes a vector of Y variables, where the m^{th} element of y₁, y_{i,m}, is equal to 1 if the m^{th} feature was present in z, and equal to 0 if the m^{th} feature was not present in z. The model can be fit so that the logarithm of the threshold eligibility value r_{z} is a linear function of the various features yᵢ. For example, the model can be fit according to relationship (4):

log(r_{z})=Σₘ₌₁^{V}βₘy_{z,m}+∈_{z} (4)

where βₘ denotes the coefficient (e.g., weight) on the m^{th} feature in the model and c_{z} denotes a random error term that is specific to each third-party content selection z. The values of the coefficients βₘ can be determined, for example, by running a linear regression of log(r_{z}) on the features z_{i,m}.

A value is assigned to the given parameter for a new event based on the features of the new event (212). The value assigned to the given parameter can be computed, for example, by applying the generated model to the features of the event. In some implementations, the value is a threshold eligibility value that is used to select third-party content in response to a current request. The threshold eligibility value can be determined, for example, by applying the model to a set of features (e.g., a features vector) for the request, which can include information included in the request as well as other information (e.g., contextual information) associated with the request. The output of the model will be the threshold eligibility value that will be used for selection of third-party content that is provided in response to the request.

In some implementations, the third-party content selected in response to a request will be a third-party content having a selection value that equals or exceeds the threshold eligibility value output by the model. The selected third-party content (or information identifying the third-party content) is then transmitted to a user device such that the third-party content is integrated into an online resource that is presented at the user device.

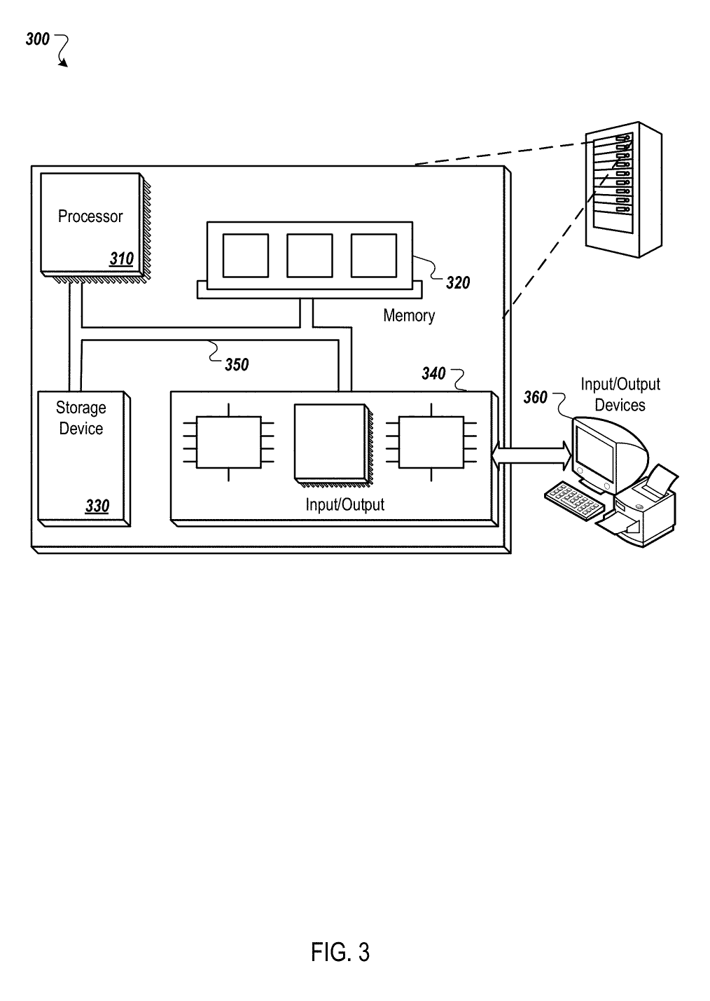

FIG. 3 is block diagram of an example computer system 300 that can be used to perform operations described above. The system 300 includes a processor 310, a memory 320, a storage device 330, and an input/output device 340. Each of the components 310, 320, 330, and 340 can be interconnected, for example, using a system bus 350. The processor 310 is capable of processing instructions for execution within the system 300. In one implementation, the processor 310 is a single-threaded processor. In another implementation, the processor 310 is a multi-threaded processor. The processor 310 is capable of processing instructions stored in the memory 320 or on the storage device 330.

The memory 320 stores information within the system 300. In one implementation, the memory 320 is a computer-readable medium. In one implementation, the memory 320 is a volatile memory unit. In another implementation, the memory 320 is a non-volatile memory unit.

The storage device 330 is capable of providing mass storage for the system 300. In one implementation, the storage device 330 is a computer-readable medium. In various different implementations, the storage device 330 can include, for example, a hard disk device, an optical disk device, a storage device that is shared over a network by multiple computing devices (e.g., a cloud storage device), or some other large capacity storage device.

The input/output device 340 provides input/output operations for the system 300. In one implementation, the input/output device 340 can include one or more of a network interface devices, e.g., an Ethernet card, a serial communication device, e.g., and RS-232 port, and/or a wireless interface device, e.g., and 802.11 card. In another implementation, the input/output device can include driver devices configured to receive input data and send output data to other input/output devices, e.g., keyboard, printer and display devices 360. Other implementations, however, can also be used, such as mobile computing devices, mobile communication devices, set-top box television client devices, etc.

Although an example processing system has been described in FIG. 3, implementations of the subject matter and the functional operations described in this specification can be implemented in other types of digital electronic circuitry, or in computer software, firmware, or hardware, including the structures disclosed in this specification and their structural equivalents, or in combinations of one or more of them.

An electronic document (which for brevity will simply be referred to as a document) does not necessarily correspond to a file. A document may be stored in a portion of a file that holds other documents, in a single file dedicated to the document in question, or in multiple coordinated files.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage media (or medium) for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a sub combination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A system for optimizing a machine learning model, comprising:
a third-party corpus database storing information related to a plurality of third-party content;
a set of computing devices that interact with the third-party corpus database and perform operations comprising:
determining an average error of a machine learning system;
defining an evaluation function that provides a result that would have been achieved using a specified value of a given parameter in prior events;
defining an expected outcome function that provides expected results for prior events based on the error of the machine learning system;
determining, for each of multiple prior events, a target value of the given parameter that causes the expected outcome function to provide a specified output for the prior event;
generating a model using the machine learning system based on features of the prior events and the determined target values of the given parameter for the prior events;
assigning a value to the given parameter for a new event based on application of the model to features of the new event;
selecting third-party content for distribution to a client device based on the assigned value of the given parameter and selection values submitted by third-party content providers; and
distributing, over a network, the selected third-party content to the client device.

2. The system of claim 1, wherein defining the evaluation function comprises defining the evaluation function to provide an output that specifies an amount of gain that would have been realized if a specified threshold eligibility value had been used to select third-party content.

3. The system of claim 2, wherein the set of computing devices perform operations further comprising evaluating selection values submitted by third-parties for each of one or more prior requests, wherein, for each request, the evaluation function provides an output of zero when no third-party has submitted a selection value that meets the threshold eligibility value, provides an output of the threshold eligibility value when a single third-party submitted a submission value meeting the threshold eligibility value, and provides an output that is greater than the threshold eligibility value when multiple third-parties submitted a submission value meeting the threshold eligibility value.

4. The system of claim 1, wherein defining the expected outcome function comprises defining the expected outcome function that outputs an amount of gain that would have been realized for a given request when the error of the machine learning system causes the actual threshold eligibility value to be higher or lower than a given threshold eligibility value for that given request, but the error does not prevent distribution of third-party content in response to the given request.

5. The system of claim 1, wherein determining the target value of the given parameter comprises determining a threshold eligibility value that maximizes the gain output by the expected outcome function.

6. The system of claim 1, wherein assigning the value to the given parameter comprises outputting, from the model, the threshold eligibility value that will be used for selection of third-party content that is provided in response to the request.

7. The system of claim 6, wherein selecting third-party content for distribution comprises selecting content having a selection value that equals or exceeds the threshold eligibility value output by the model.

8. A method of optimizing a machine learning system comprising:
determining an average error of a machine learning system;
defining an evaluation function that provides a result that would have been achieved using a specified value of a given parameter in prior events;
defining an expected outcome function that provides expected results for prior events based on the error of the machine learning system;
determining, for each of multiple prior events, a target value of the given parameter that causes the expected outcome function to provide a specified output for the prior event;
generating, by one or more computing devices, a model using the machine learning system based on features of the prior events and the determined target values of the given parameter for the prior events;
assigning, by one or more computing devices, a value to the given parameter for a new event based on application of the model to features of the new event;
selecting, by one or more computing devices, third-party content for distribution to a client device based on the assigned value of the given parameter and selection values submitted by third-party content providers; and
distributing, over a network, the selected third-party content to the client device.

9. The method of claim 8, wherein defining the evaluation function comprises defining the evaluation function to provide an output that specifies an amount of gain that would have been realized if a specified threshold eligibility value had been used to select third-party content.

10. The method of claim 9, further comprising evaluating selection values submitted by third-parties for each of one or more prior requests, wherein, for each request, the evaluation function provides an output of zero when no third-party has submitted a selection value that meets the threshold eligibility value, provides an output of the threshold eligibility value when a single third-party submitted a submission value meeting the threshold eligibility value, and provides an output that is greater than the threshold eligibility value when multiple third-parties submitted a submission value meeting the threshold eligibility value.

11. The method of claim 8, wherein defining the expected outcome function comprises defining the expected outcome function that outputs an amount of gain that would have been realized for a given request when the error of the machine learning system causes the actual threshold eligibility value to be higher or lower than a given threshold eligibility value for that given request, but the error does not prevent distribution of third-party content in response to the given request.

12. The method of claim 8, wherein determining the target value of the given parameter comprises determining a threshold eligibility value that maximizes the gain output by the expected outcome function.

13. The method of claim 8, wherein assigning the value to the given parameter comprises outputting, from the model, the threshold eligibility value that will be used for selection of third-party content that is provided in response to the request.

14. The method of claim 13, wherein selecting third-party content for distribution comprises selecting content having a selection value that equals or exceeds the threshold eligibility value output by the model.

15. A non-transitory computer readable medium storing instructions that upon execution by one or more data processing apparatus cause the one or more data processing apparatus to perform operations comprising:
determining an average error of a machine learning system;
defining an evaluation function that provides a result that would have been achieved using a specified value of a given parameter in prior events;
defining an expected outcome function that provides expected results for prior events based on the error of the machine learning system;
determining, for each of multiple prior events, a target value of the given parameter that causes the expected outcome function to provide a specified output for the prior event;
generating a model using the machine learning system based on features of the prior events and the determined target values of the given parameter for the prior events;
assigning a value to the given parameter for a new event based on application of the model to features of the new event;
selecting third-party content for distribution to a client device based on the assigned value of the given parameter and selection values submitted by third-party content providers; and
distributing, over a network, the selected third-party content to the client device.

16. The computer readable medium of claim 15, wherein defining the evaluation function comprises defining the evaluation function to provide an output that specifies an amount of gain that would have been realized if a specified threshold eligibility value had been used to select third-party content.

17. The computer readable medium of claim 16, further comprising evaluating selection values submitted by third-parties for each of one or more prior requests, wherein, for each request, the evaluation function provides an output of zero when no third-party has submitted a selection value that meets the threshold eligibility value, provides an output of the threshold eligibility value when a single third-party submitted a submission value meeting the threshold eligibility value, and provides an output that is greater than the threshold eligibility value when multiple third-parties submitted a submission value meeting the threshold eligibility value.

18. The computer readable medium of claim 15, wherein defining the expected outcome function comprises defining the expected outcome function that outputs an amount of gain that would have been realized for a given request when the error of the machine learning system causes the actual threshold eligibility value to be higher or lower than a given threshold eligibility value for that given request, but the error does not prevent distribution of third-party content in response to the given request.

19. The computer readable medium of claim 15, wherein determining the target value of the given parameter comprises determining a threshold eligibility value that maximizes the gain output by the expected outcome function.

20. The computer readable medium of claim 15, wherein assigning the value to the given parameter comprises outputting, from the model, the threshold eligibility value that will be used for selection of third-party content that is provided in response to the request, and wherein selecting third-party content for distribution comprises selecting content having a selection value that equals or exceeds the threshold eligibility value output by the model.
